(19) United States
(12) Patent Application Publication
(10) Pub. No.: US 2008/0256864 A1
(43) Pub. Date: Oct. 23, 2008

(54) Skylight Protector

(76) Inventors: Richard B. Stoffels, Eden Prairie, MN (US); James G. Sidla, Monticello, MN (US)

Correspondence Address: Alan D. Kamrath, Esq.;NIKOLAI & MERSEREAU, P.A., Suite 820, 900 Second Avenue South, Minneapolis, MN, 55402-3325, US

(21) Appl. No.: 11/738,716

(22) Filed: Apr. 23, 2007

(51) Int. Cl. E06B 3/68

(52) U.S. Cl. 49/55

(57) ABSTRACT

A protector (10) includes first and second frames (30a and 30b) spaced from each other and mounted at two opposite sides of a structure (80). Bach of the first and second frames (30a and 30b) includes two columns (34) and a cross bar (32) interconnected between the columns (34). Each column (34) includes a base (12a, 12b, 12c, 12d) mounted to a bottom thereof. Connecting rods (40) are mounted between the first and second frames (30a and 30b) and each include first and second ends (41) removably interconnected to the cross bars (32). The connecting rods (40) are spaced from each other and located above and extend across the structure (80). A brace (50) includes a first end (52) pivotably mounted to one of the columns (34) and a second, end engaged with the structure (80). The level of the connecting rods (40) is adjustable to suit the height of the structure. Weights (18) may be mounted to the bases (12a-12d) to increase the resistance of the protector (10) to wind lift.

### BACKGROUND OF THE INVENTION

The present invention relates to a protector. More particularly, the present invention relates to a skylight protector that is adjustable in size to allow easy installation for protecting skylights of various sizes.

Roofs often include skylights to admit natural light to interior space. People are often required to be on roofs for a variety of reasons. For example, roof maintenance is sometimes required such as for replacement of roofing materials. Such people on roofs might accidentally run into or tall through skylights on the roof.

Therefore, a need exists for a protector that provides protection around skylights on roofs. Such protectors must have the ability to he easily and quickly installed around various sizes of skylights without damaging the roof while avoiding risks of wind uplift and the like.

### BRIEF SUMMARY OF THE INVENTION

The present invention solves this need and other problems in the field of security apparatus by providing, in a first aspect, a protector that can be easily installed for protecting a structure.

In another aspect of the present invention, a protector includes a brace for providing reinforced support for a structure.

In still a further aspect of the present invention, a protector includes four bases that engage with a cant strip extending between corners of a skylight.

A protector according to the preferred teachings of the present invention includes first and second frames spaced from each other and adapted to be mounted at two opposite sides of a structure including but not limited to a skylight. In a preferred form, each of the first and second frames includes two column spaced from each other and a cross bar interconnected between the columns. First, second, third, and fourth bases are respectively attached to bottoms of the columns of the first and second frames and spaced from each other.

In the preferred form, the first, second, third, and fourth bases respectively include first, second, third, and fourth posts extending upward therefrom. When the first, second, third, and fourth bases are placed on a surface on which the structure is located, a width is defined between the first and second posts and between, the third and fourth posts, and a length is defined between the first and third posts and between the second and fourth posts. The first and second frames are spaced from each other in a direction parallel to the length. The columns of each of the first and second frames are spaced from each other is a direction parallel to the width. The cross bars extend in a direction parallel to the width. The columns of the first frame are respectively and slideably mounted relative to the first and second posts and allow adjustment parallel to the first and second posts. The columns of the second frame are respectively and slideably mounted relative to the third and fourth posts and allow adjustment parallel to the third and fourth posts. This allows the first and second frames to be lifted to a desired level above the structure.

In the preferred form, a plurality of connecting rods are mounted between the first and second frames and each include first and second ends removably interconnected to the cross bars. The first end of each connecting rod is slideable along the cross bar of the first frame and not slideable in a direction parallel to the length. Each second end of each connecting rod is slideable along the cross bar of the second frame and not slideable in a direction parallel to the length. The connecting rods are spaced from each other when the first and second ends of each connecting rod are positioned on the cross bars. In the preferred form, each of the first and second ends of the connecting rods includes a coupler mounted thereon. Each coupler is substantially U-shaped, and includes inner and outer arms and an interconnecting portion between the inner and outer arms. The inner and outer arms define a spacing therebetween for slideably receiving the cross bar.

In the preferred form, at least one weight is removably mounted on top of each of the first, second, third, and fourth bases and includes a through-hole through which an associated one of the first, second, third, and fourth posts extends. These weights increase resistance of the protector to wind lift.

The protector according to the preferred teachings of the present invention may further include a brace including a first end pivotably mounted to one of the columns and a second end engaged with the structure to provide reinforced support in the most preferred form, the brace includes a collar pivotably mounted around the column. A sleeve extends radially outward from the collar. An engaging rod has a first end slideably received in the sleeve and the second end which is forked and presses against a corner of the structure.

In a preferred form of the protector according to the preferred teachings utilized with a skylight mounted on a roof in which a cant strip is mounted on the roof and extends between four corners of the skylight, each of the first, second, third, and fourth bases includes a notch having first and second edges perpendicular to each other. The first and second edges of the notches of the first, second, third, and fourth bases are respectively engaged with two margins of the cant strip that are perpendicular to each other and respectively parallel to two sides of each corner of the skylight.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a diagrammatic perspective view of a skylight and a protector according to the preferred teachings of the present invention.

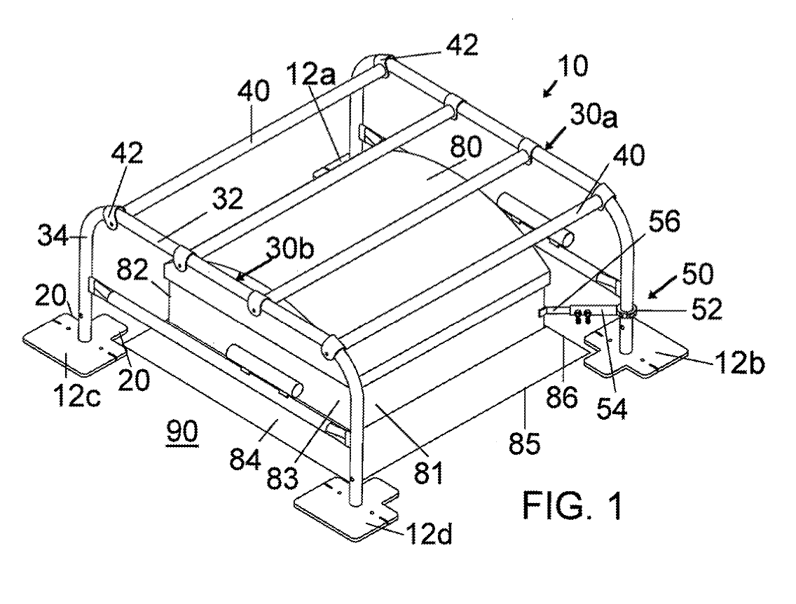

FIG. 2 shows an exploded perspective view of the protector according to the preferred teachings of the present invention.

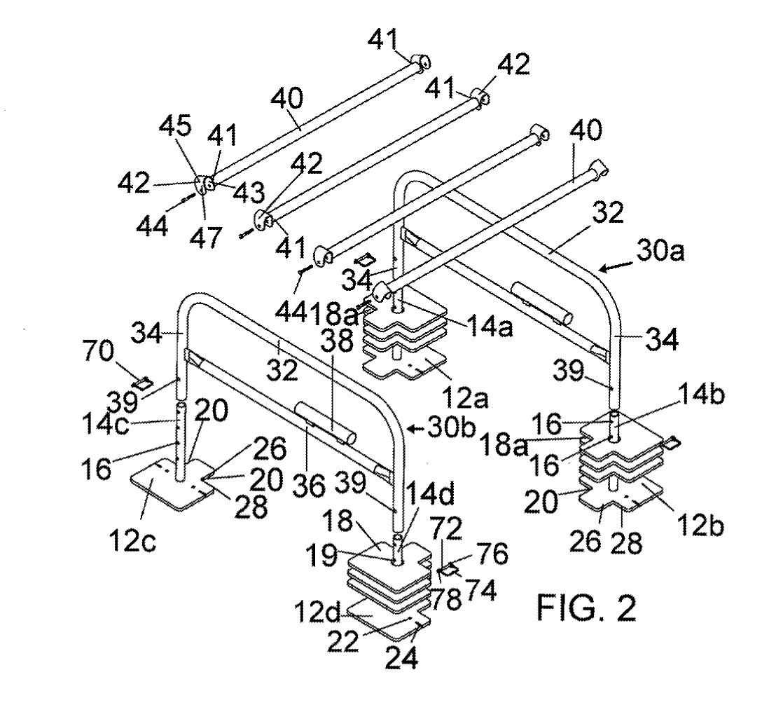

FIG. 3 is a partial, sectional view illustrating mounting of an end of a connecting rod to a cross bar of the protector according to the preferred teachings of the present invention.

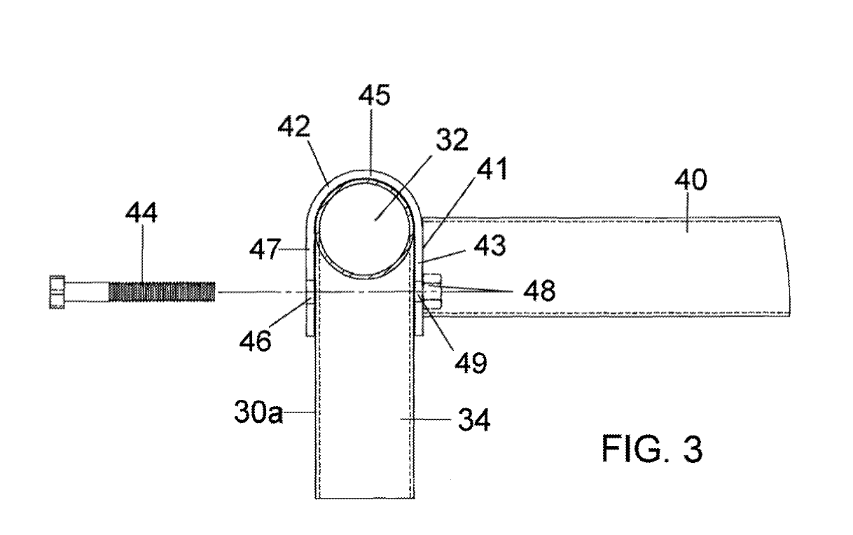

FIG. 4 is an enlarged, partial perspective view illustrating a brace of the protector according to the preferred teachings of the present invention.

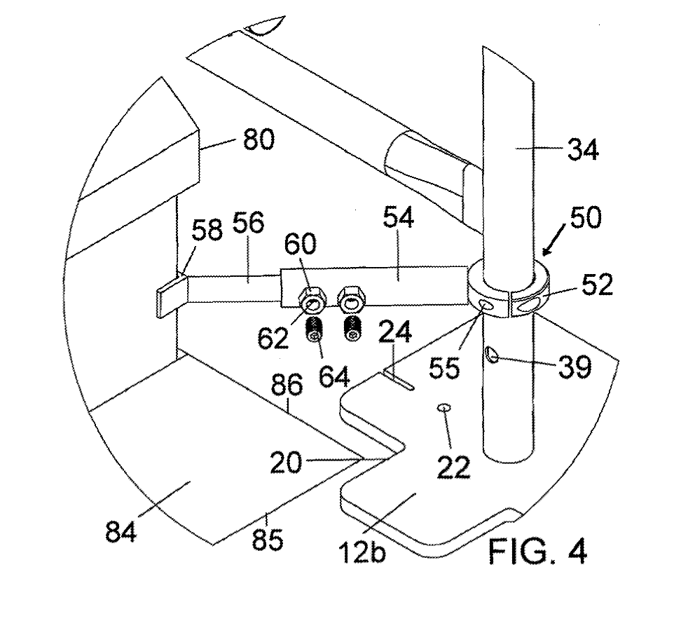

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “end”, “side”, “portion”, “periphery”, “radial”, “outward”, “upward”, “spacing”, “length”, “width”, “height”, and similar terms are used herein, it should be understood that these terms have reference only to the structure shown in the drawings as it would appear to a person viewing the drawings and are utilized only to facilitate describing the preferred embodiment,

### DETAILED DESCRIPTION OF THE PREFERRED EMBODIMENT

A protector according to the preferred teachings of the present invention is shown in the drawings and generally designated 10. The protector 10 is provided around and above a structure including but not limited to a skylight 80 that is mounted on a roof 90 for admitting natural light. A cant strip 84 is mounted on the roof 90 and extends between four corners 82 of the skylight 80. The cant strip 84 includes two margins 85 and 86 that are perpendicular and that are respectively parallel to two sides 81 and 83 of each corner 82 of the skylight 80. An example of the functions of the cant strip 84 is to provide a gentler angle for built-up membranes (not shown) to follow when transitioning from the roof deck to the sides 81 and 83 of the skylight 80.

The protector 10 according to the preferred teachings of the present invention includes first, second, third, and fourth bases 12a, 12b, 12c, and 12d spaced from each other and respectively adjacent to the corners 82 of the skylight 80. Each of the first, second, third, and fourth bases 12a-12d is substantially rectangular in section, hi a preferred form, each of the first, second, third, and fourth bases 12a-12d includes a substantially square or rectangular notch 20 in a corner thereof and having first and second edges 26 and 28 that are perpendicular to each other. The first and second edges 26 and 28 of the notch 20 of each of the first, second, third, and fourth bases 12a-12d are respectively engaged with the margins 85 and 86 of the cant strip 84. Thus, undesired displacements of the bases 12a-12d and the assembled protector 10 are avoided. In the most preferred form shown, each of the first, second, third, and fourth bases 12a-12d includes a pair of notches 20 in a pair of corners thereof, forming a substantially T-shaped structure allowing easy installation of the bases 12a-12d without the need of choosing bases 12a-12d with a notch 20 in a specific corner and engaging the notch 20 with specific sections of the margins 85 and 86 of the cant strip 84. Other shapes of the bases 12a-12d would be within the skill of the art,

According to the preferred form, the first, second, third, and fourth bases 12a-12d respectively include first, second, third, and fourth posts 14a, 14b, 14c, and 14d extending upward therefrom. In the most preferred form shown, each of the posts 14a-14d includes a plurality of vertically spaced engaging holes 16. The bases 12a-12d may be placed on the roof 90 to define a width between the first and second posts 14a and 14b and between the third and fourth posts 14c and 14d corresponding to the width of the skylight 80 and to define a length between the first and third posts 14a and 14c and between the second and fourth posts 14b and 14d corresponding to the length of the skylight 80. In a preferred form, the bases 12a-12d are placed on the roof 90 without using any bolts or screws that may damage the roof 90. However, in the most preferred form shown, each of the bases 12a-12d includes one or more slits 24 for receiving fasteners including but not limited to nails (not shown) and/or one or more fixing holes 22 for receiving fasteners including but not limited to lug bolts (not shown). This allows the bases 12a-12d to be connected to the roof 90 such as for use for new construction where roofing material has not been installed. Thus, the bases 12a-12d can be fixed to the roof 90 by fasteners to provide a protector 10 that stands more reliably.

In the preferred form shown, first and second frames 30a and 30b are mounted at two opposite sides of the skylight 80 and parallel to and spaced from each other in a direction parallel to the length. Specifically, each of the first and second frames 30a and 30b includes two columns 34 spaced from each other corresponding to the width between the posts 14a and 14b and posts 14c and 14d. A cross bar 32 is interconnected between the columns 34. In the most preferred form shown, each column 34 of each of the first and second frames 30a and 30b is tubular and mounted around one of the posts 14a-14d. Further, each column 34 of each of the first and second frames 30a and 30b includes a hole 39 selectively aligned with one of the engaging holes 16 of the first, second, third, and fourth posts 14a-14d. Thus, the columns 34 of the first frame 30a are respectively and slideably mounted relative to the first and second posts 14a and 14b and allow adjustment parallel to the first and second posts 14a and 14b, and the columns 34 of the second frame 30b are respectively and slidably mounted relative to the third and fourth posts 14c and 14d and allow adjustment parallel to the third and fourth posts 14c and 14d. After the first and second frames 30a and 30b have been lifted to move the cross bars 32 to a desired level above the skylight 80, a fastener 70 is mounted to each column 34 of each of the first and second frames 30a and 30b to position the columns 34 of the first and second frames 30a and 30b on the posts 14a-14d. In the preferred form shown, each fastener 70 is a substantially U-shaped clasp 74 having first and second ends 76 and 78 defining a spacing larger than an outer diameter of one of the columns 34. Each fastener 70 further includes a pin 72 having a first end pivotally connected to the first end 76 of the U-shaped clasp 74 and a second end releasably engaged with the second end 78 of the U-shaped clasp 74. Furthermore, the pin 72 extends through the hole 39 of one of the columns 34 and one of the engaging holes 16 of an associated one of the first, second, third, and fourth posts 14a-14d. The fasteners 70 can be held in place or removed without the use of tools. Other arrangements of the fasteners 70 would be within the skill of the art. As an example, each fastener 70 can be in the form of a pin in the simplest form. In the preferred form shown, a bar 36 is interconnected between the columns 34 of each of die first and second frames 30a and 30b and below the cross bar 32. In the form shown, a tube 38 is mounted to each bar 36 for holding parts books, product information and the like.

In the preferred form shown, a plurality of connecting rods 40 are connected between the first and second frames 30a and 30b and having a length corresponding to the length between posts 14a and 14c and posts 14b and 14d. Each competing rod 40 includes first and second ends 41 interconnected to the cross bars 32 of the first and second frames 30a and 30b. Specifically, each of the first and second ends 41 of each connecting rod 40 includes a coupler 42 mounted thereon. The coupler 42 is substantially U-shaped, and includes inner and outer arms 43 and 47 and an interconnecting portion 45 between the inner and outer arms 43 and 47. The inner and outer arms 43 and 47 define a spacing therebetween for slideably receiving the cross bar 32. The inner arm 43 of each coupler 42 is fixed to one of the first and second ends 41 of the connecting rods 40 and has a screw hole 49. The outer arm 47 of each coupler 42 has a bolt hole 46 aligned with the screw hole 49. A bolt 44 is extended through the screw hole 49 and the bolt hole 46 of each coupler 42 and located on an opposite side of the cross bar 32 than the interconnecting portion 45. In the most preferred form, a nut 48 is fixed to the inner arm 43 of each coupler 42 and located in one of the first and second ends 41 of one of the connecting rods 40, and the bolt 44 is threadedly engaged with the nut 48. The bolt 44 is moveable between a tightened position for positioning the associated connecting rod 40 to the cross bar 32 and a loosened position allowing sliding movement of the associated connecting rod 40 along the cross bar 32. Thus, the first and second ends 41 of the connecting rods 40 are mounted to the cross bars 32 of the first and second frames 30a and 30b, with the bolts 44 initially in the loosened positions allowing the first ends 41 of the connecting rods 40 to slide along the cross bar 32 of the first, frame 30a and to allow the second ends 41 of the connecting rods 40 to slide along the cross bar 32 of the second frame 30b. The first and second ends 41 of the connecting rods 40 are then positioned in a spaced relation by tightening the bolts 44 such that the connecting rods 40 are spaced from each other in a desired manner, and specifically to be spaced within government workplace regulations. Installation of the connecting rods 40 and adjustment in the spacing between the connecting rods 40 can be easily achieved.

In the preferred form shown, a brace 50 extends in a radial direction away from one or more of the columns 34 and engages with the skylight 80 to provide reinforced support. A first end of the brace 50 is pivotally mounted to the column 34 in the preferred form by a collar 52 pivotably around the column 34. A sleeve 54 extends radially outward from the collar 52. An engaging rod 56 has a first end slideably received in the sleeve 54 and a second, forked end 58 pressing against a corner 82 of the skylight 80. The sleeve 54 includes two through-holes 62 and two nuts 60 whose screw holes (not labeled) are aligned with the through-holes 62 to provide a threaded connection. Two bolts 64 are extended through the nuts 60 and the through-holes 62 of the sleeve 54 and to be in frictional contact with a portion of the engaging rod 56 in the sleeve 54 for retaining the engaging rod 56 in place. Other threaded connections would be within the skill of the art. As an example, the nuts can be omitted, and the through-holes 62 could be threaded Furthermore, fewer or a greater number of through-holes 62, bolts 64, and nuts 60 can be utilized to achieve the retaining effect for the engaging rod 56. Due to the slideable receipt of engaging rod 56 in sleeve 54 in the preferred form, brace 50 has an adjustable length in the radial direction. In the most preferred form shown, the collar 52 includes a radial through-hole 55 and a set screw (not shown) is extended through the radial through-hole 55 and to be in frictional contact with the column 34 to retain the collar 52 in place. Other arrangements for positioning the collar 52 on the column 34 would be within the skill of the art.

A plurality of weights 18 may be mounted on top of each of the first, second, third, and fourth bases 12a-12d and each include a through-hole 19 through which an associated one of the first, second, third, and fourth posts 14a-14d and column 34 extend Weights 18 can be placed upon posts 14a-14d before columns 34 are slid thereon. The weights 18 increase resistance of the protector 10 to wind lift. It was found that an extra weight 18 on each of the first, second, third ad fourth bases 12a-12d increased the resistance of the protector 10 to wind lift by 18 MPH, and a stack of five weights 18 on each of the first, second, third, and fourth bases 12a-12d provided the protector 10 with a wind lift capability of 200 MPH. The shape of the weights 18 may be identical to or different from the bases 12a-12d. In the most preferred, form, the weights 18 are T-shaped in section as the bases 12a-12d. Specifically, each weight 18 includes a pair of notches 18a one of which is selectively engaged with the margins 85 and 86 of the cant strip 84. This further avoids undesired displacement of the protector 10 and enhances the wind lift resistant effect while allowing easy installation.

The protector 10 according to the preferred teachings of the present invention can be used with a structure including but not limited to a skylight 80 such as to protect workers on a roof 90 on which the skylight 80 is mounted. The protector 10 according to the preferred teachings of the present invention can be easily installed around the structure. By the selection of the desired width of frames 30a and 30b and the desired length of connecting rods 40, the protector 10 of the present invention can be matched to the structure and allows easy adjustment in the height to suit structures of various heights. Furthermore, the protector 10 according to the preferred teachings of the present invention resists relative movement to the structure when using the brace 50 and the weights 18 without requiring securement to the structure or the roof 90. Likewise, undesired displacements of the bases 12a-12d as well as the assembled protector 10 according to the preferred teachings of the present invention are unlikely to occur, as the notches 20 of the bases 12a-12d are engaged with the margins 85 and 86 of the cant strip 84. For example, when a worker working on the roof falls onto the protector 10, horizontal movements of the bases 12a-12d resulting from a horizontal component of a gravitational force imparted from the worker to the protector 10 are stopped by the engagement between the first and second edges 26 and 28 of the notches 20 of the bases 12a-12d and the margins 85 and 86 of the cant strip 84, whereas a vertical component of the gravitational force imparted from the worker to the protector 10 prevents the bases 12a-12d from riding up the cant strip 84.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A protector comprising, in combination;
first and second bases spaced from each other, with the first base including a first post extending upward therefrom, with the second base including a second post extending upward therefrom, and with the first and second posts defining a width therebetween;
third and fourth bases spaced from each other and spaced from the first and second bases, with the third base including a third post extending upward therefrom, with the fourth base including a fourth post extending upward therefrom, with the third and fourth posts defining the width therebetween, with the first and third posts defining a length therebetween, and with the second and fourth posts defining the length therebetween;
first, and second frames spaced from each other in a direction parallel to the length, with each of the first and second frames including two columns spaced from each other in a direction parallel to the width, with each of the first and second frames including a cross bar interconnected between the columns and extending in a direction parallel to the width, with the columns of the first frame being respectively and slideably mounted relative to the first and second posts and allowing adjustment parallel to the first and second posts, and with the columns of the second frame being respectively and slideably mounted relative to the third and fourth posts and allowing adjustment parallel to the third and fourth posts; and
a plurality of connecting rods each including first and second ends removably interconnected to the cross bars of the first and second frames, with each of the first ends of each of the plurality of connecting rods being slideable along the cross bar of the first frame and not slideable in a direction parallel to the length, with each of the second ends of each of the plurality of connecting rods being slideable along the cross bar of the second frame and not slideable in a direction parallel to the length, and with the plurality of the connecting rods being spaced from each other when the first and second ends of each of the plurality of connecting rods are positioned on the cross bars.

2. The protector as claimed in claim 1, with each of the first and second ends of the plurality of connecting rods including a coupler mounted thereon, with each of the couplers being substantially U-shaped and including inner and outer arms and an interconnecting portion between the inner and outer arms, with the inner and outer arms defining a spacing therebetween for slideably receiving the cross bar, with the inner arm of each of the couplers being fixed to one of the first and second ends of the connecting rods and having a screw hole, with the outer arm of each of the couplers having a bolt hole aligned with the screw hole, with the protector further comprising, in combination; a bolt extending through the screw hole and the bolt hole of each of the couplers and located on an opposite side of the cross bar than the interconnecting portion, and with the bolt being moveable between a tightened position for positioning the associated connecting rod to the cross bar and a loosened position allowing sliding movement of the associated connecting rod along the cross bar.

3. The protector as claimed in claim 1, with the first, second, third, and fourth bases being adapted to be mounted on a surface, with each of the first, second, third, and fourth bases further including a fixing hole, and with each of the first, second, third, and fourth bases being adapted to be fixed to the surface by extending a bolt through the fixing hole of each of the first, second, third, and fourth bases into the surface.

4. The protector as claimed in claim 1, with the first, second, third, and fourth bases being adapted to be mounted on a surface, with each of the first, second, third, and fourth bases further including a slit, and with each of the first, second, third, and fourth bases being adapted to be fixed to the surface by extending a nail through the slit of each of the first, second, third, and fourth bases into the surface.

5. The protector as claimed in claim 1, with each of the first, second third, and fourth posts including a plurality of vertically spaced engaging holes, with each of the columns including a hole selectively aligned with one of the engaging holes of the first, second, third, and fourth posts, with the protector further comprising, in combination: a fastener extending through the hole of each of the columns and one of the engaging holes of the first, second, third, and fourth posts for positioning the columns on the first, second, third, and fourth posts.

6. The protector as claimed in claim 5, further comprising, in combination: at least one weight removably mounted on top of each of the first, second, third, and fourth bases and including a through-hole through which an associated one of the first, second, third, and fourth posts extends.

7. The protector as claimed in claim 1, further comprising, in combination: at least one weight removably mounted on top of each of the first, second, third, and fourth bases and including a through-hole through which an associated one of the first, second, third, and fourth posts extends.

8. The protector as claimed in claim 1, further comprising, in combination: a brace including a first end pivotably mounted to one of the columns, with the brace extending in a radial direction away from the column, with the brace further including a second end adapted to be engaged with a structure mounted below the connecting rods, between the first and second frames and between the width.

9. The protector as claimed in claim 8, with the brace including an adjustable length in the radial direction, and with the second end of the brace being a forked end adapted to press against a corner of the structure.

10. The protector as claimed in claim 9, with the brace comprising, in combination; a collar pivotably mounted around one of the columns and forming the first end of the brace; a sleeve extending radially outward from the collar; and an engaging rod having a first end slideably received in the sleeve and the second end of the brace.

11. The protector as claimed in claim 10, with the sleeve further including a through-hole in a periphery thereof and including a threaded connection, with a bolt extending through the threaded connection and the through-hole of the sleeve and to be in frictional contact with a portion of the engaging rod in the sleeve for retaining the engaging rod in place.

12. A protector comprising, in combination:
first and second frames spaced from each other and adapted to be mounted at two opposite sides of a structure, with each of the first and second frames including two columns spaced from each other, with each of the first and second frames including a cross bar interconnected between the columns, and with each of the columns of the first and second frames including a base mounted to a bottom thereof;
a plurality of connecting rods each including first and second ends interconnected to the cross bars of the first and second frames, with the plurality of connecting rods being spaced from each other and adapted to be located above and extend across the structure; and
a brace including a first end pivotably mounted to one of the columns, with the brace extending in a radial direction away from the column, with the brace including a second end adapted to be engaged with the structure.

13. The protector as claimed in claim 12, with the brace including an adjustable length in the radial direction, and with the second end of the brace being a forked end adapted to press against a corner of the structure.

14. The protector as claimed in claim 13, with the brace comprising, in combination; a collar pivotably mounted around one of the columns and forming the first end of the brace; a sleeve extending radially outward from the collar; and an engaging rod having a first end slideably received in the sleeve and the second end of the brace.

15. The protector as claimed in claim 14, with the sleeve further including a through-hole in a periphery thereof and including a threaded connection, with a bolt extending through the threaded connection and the through-hole of the sleeve and to be in frictional contact with a portion of the engaging rod in the sleeve for retaining the engaging rod in place.

16. The protector as claimed in claim 12, with each of the bases including a post, extending upward therefrom, with each of the posts being slideably mounted relative to one of the columns of the first and second frames and allowing adjustment parallel to the posts, with each of the first and second ends of the plurality of connecting rods and including a coupler mounted thereon, with each of the couplers being substantially U-shaped and including inner and outer arms and an interconnecting portion between the inner and outer arms, with the inner and outer arms defining a spacing therebetween for slideably receiving the cross bar, with the inner arm of each of the couplers being fixed to one of the first and second ends of the connecting rods and having a screw hole, with the outer arm of each of the couplers having a bolt hole aligned with the screw hole, with the protector further comprising, in combination: a bolt extending through the screw hole and the bolt hole of each of the couplers and located on an opposite side of the cross bar than the interconnecting portion, with the bolt being moveable between a tightened position for positioning the associated connecting rod to the cross bar and a loosened position allowing sliding movement of the associated connecting rod along the cross bar.

17. A roof assembly comprising, in combination:
a skylight adapted to be mounted on a roof and having four corners each having two sides;
a cant strip mounted on the roof and extending between the corners of the skylight, and with the cant strip having two margins perpendicular to each other and respectively parallel to the sides of the corners;
first, second, third, and fourth bases spaced from each other and respectively adjacent to the corners of the skylight, with the first base including a first post extending upward therefrom, with the second base including a second post extending upward therefrom, with the first and second posts defining a width therebetween, with the third base including a third post extending upward therefrom, with the fourth base including a fourth post extending upward therefrom, with the third and fourth posts defining the width therebetween, with the first and third posts defining a length therebetween, with the second and fourth posts defining the length therebetween, with each of the first, second, third, and fourth bases further including a notch, with the notch including a first edge and a second edge perpendicular to the first edge, and with the first and second edges of the notch of each of the first, second, third, and fourth bases being respectively engaged with the margins of the cant strip;
first and second frames spaced from each other in a direction parallel to the length, with each of the first and second frames including two columns spaced from each other in a direction parallel to the width, with each of the first and second frames including a cross bar interconnected between the columns arid extending in a direction parallel to the width, with the columns of the first frame being respectively and slideably mounted relative to the first and second posts and allowing adjustment parallel to the first and second posts, and with the columns of the second frame being respectively and slideably mounted relative to the third and fourth posts and allowing adjustment parallel to the third and fourth posts; and
a plurality of connecting rods each including first and second ends removably interconnected to the cross bars of the first and second frames, with the plurality of connecting rods being spaced from each other and extending across the width and across the length, and with the plurality of connecting rods being located above the skylight.

18. The roof assembly as claimed in claim 17, further comprising, in combination: a brace including a first end pivotably mounted to one of the columns, with the brace extending in a radial direction away from the column, with the brace further including a second end engaged with the skylight.

19. The roof assembly as claimed in claim 18, with the brace including a collar pivotably mounted around one of the columns; a sleeve extending radially outward from the collar; and an engaging rod having a first end slideably received in the sleeve and a second, forked end pressing against one of the corners of the skylight, with the sleeve further including a through-hole in a periphery thereof and including a threaded connection, and with a bolt extending through the threaded connection and the through-hole of the sleeve and to be in frictional contact with a portion of the engaging rod in the sleeve for retaining the engaging rod in place.

20. The roof assembly as claimed in claim 17, with each of the first and second ends of the plurality of connecting rods including a coupler mounted thereon, wife each of the couplers being substantially U-shaped and including inner and outer arms and an interconnecting portion between the inner and outer arms, with the inner and outer arms defining a spacing therebetween for slideably receiving the cross bar, wife the inner arm of each of the couplers being fixed to one of the first and second ends of the connecting rods and having a screw hole, with the outer arm of each of the couplers having a bolt hole aligned with the screw hole, with the roof assembly farther including, in combination: a bolt extending through the screw hole and the bolt hole of each of the couplers and located on an opposite side of the cross bar than the interconnecting portion, and with the bolt being moveable between a tightened position for positioning the associated connecting rod to the cross bar and a loosened position allowing sliding movement of the associated connecting rod along the cross bar.
